(19) United States
(12) Patent Application Publication
(10) Pub. No.: US 2004/0159253 A1
(43) Pub. Date: Aug. 19, 2004

(54) Method and apparatus for marking objects, e.g. boards, in a pile

(76) Inventor: Antti Korhonen, Lahti (FI)

Correspondence Address: BIRCH STEWART KOLASCH & BIRCH, PO BOX 747, FALLS CHURCH, VA, 22040-0747, US

(21) Appl. No.: 10/478,133

(22) PCT Filed: May 21, 2002
(86) PCT No.: PCT/FI02/00432

(30) Foreign Application Priority Data
May 21, 2001 (FI) 20011064

(51) Int. Cl. B41C 1/00

(52) U.S. Cl. 101/483

(57) ABSTRACT

A method and an apparatus for making e.g. boardlike objects (11) arranged in a pile (12), in which method the objects are marked with a marking printed by a print head (26) and containing e.g. information about the object. To improve the marking quality, the objects are pressed together to reduce or eliminate gaps between them in the direction of compression, and the marking is made on an edge of the object that is parallel to the direction of compression of the objects.

The present invention relates to a method as defined in the preamble of claim 1 and to an apparatus for marking e.g. boardlike objects in a pile.

In the manufacture of various board products, such as e.g. chipboards, the board may be provided with a marking giving information such as manufacturer, type, date of manufacture of the board or the like. There are systems in which such a marking is made in an individual board, e.g. on an edge of the board. Systems are also known in which the marking is made on the edge of the boards while the boards are in a pile. The marking is produced using e.g. an ink jet print head or equivalent.

A drawback regarding the marking of boards is that the piles of boards may have air gaps between boards due e.g. to bending of the boards, a consequence of which is e.g. that the text is not always printed in the right place in the printing area and that the printing ink used for the marking may spread between the boards, staining the surface of the product. Because of the gaps, the height dimension of the pile is undeterminable.

The object of the present invention is to achieve a new type of method and apparatus for marking objects in a pile that make it possible to avoid the drawbacks of prior art.

The invention is mainly characterized in that, according to the invention, the boards in the pile of boards are pressed together especially to eliminate errors caused by air gaps between the boards. In a solution according to the invention, pressure is applied from the top of the pile of boards by using a pressing element that compresses the pile of boards by its own weight. In this situation, the pile is e.g. on a conveyor at a marking station.

In more definite terms, the invention is characterized by what is presented in the claims.

The invention makes it possible to achieve a substantial improvement of the print quality. In addition, the invention allows the pile height to be more accurately determined in the printing station because air gaps between boards have been eliminated.

In the following, the invention will be described in detail by the aid of an embodiment example with reference to the attached drawings, wherein

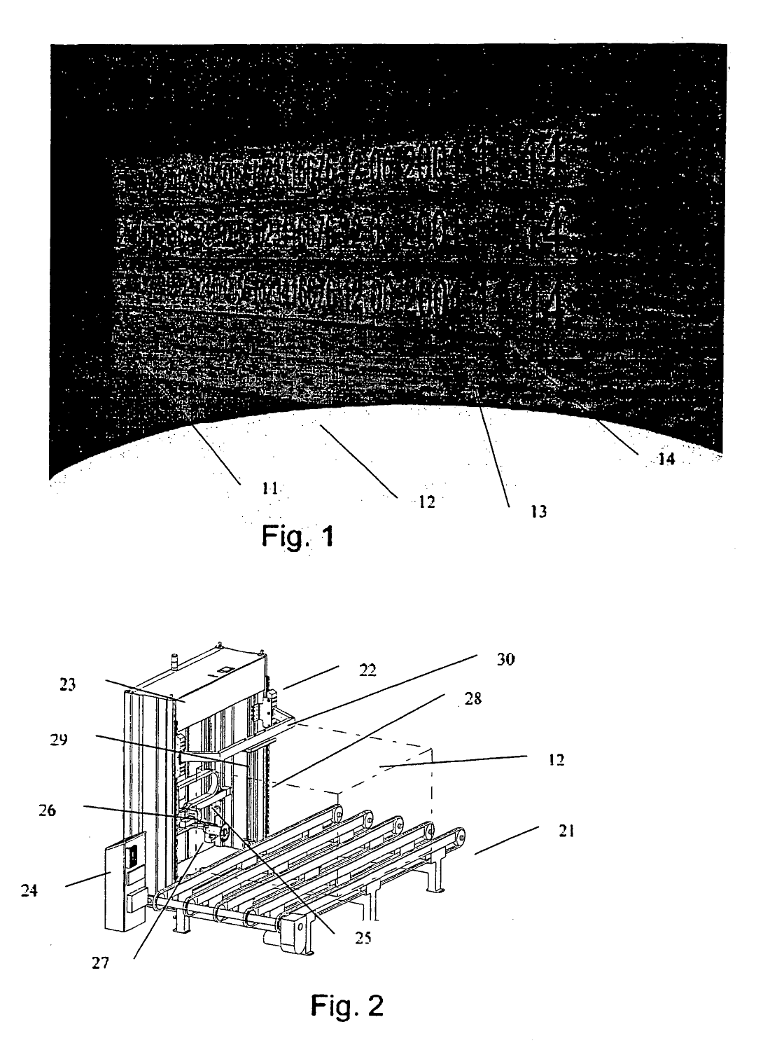

FIG. 1 presents a pack of boards provided with a marking on one edge of the boards, and

FIG. 2 presents a marking station comprising a pressing device according to the invention.

FIG. 1 shows chipboards 11 arranged one over the other as a pile 12. Printed on an edge 13 of each board 11 is a marking 14 consisting of information such as type, size, manufacturer, date of manufacture of the board and similar data. The pile 12 of boards may consist of a plurality of boards placed on top of each other, and its height may typically be e.g. about 1 m. In addition, the pile may comprise e.g. protective boards placed under and over it.

The pile of boards 12 is brought e.g. on a chain conveyor 21 (FIG. 2) to a marking station 22, where a marking as shown in FIG. 1 is made on the edge of each board. The station consists of a frame part 23, a printer unit 24 controlling the printing, and a system, e.g. a PLC system (not shown in the figure) used for controlling the movable parts of the marking station. Fitted in the frame part 23 are guide bars 25 permitting motion in the directions of the three principal axes x, y, z, with a print head 26, e.g. an ink jet print head fitted on the guide bars, and actuators 27 for moving and guiding the print head in directions x, y, z at a suitable short distance from the edge of the pile 12 e.g. during a marking operation.

In addition to this, the frame part is provided with vertical guide bars 28 with a pressing element 30 fitted on them and moved vertically by means of an electric motor drive and cogged belts 29. The pressing element 30, typically weighing 100-150 kg, compresses the pile of boards from above in its edge area while the pile is on the conveyor. For this purpose, the electric drive is provided with a freewheel clutch mounted e.g. on its shaft, allowing the pressing element 30 to be first lowered with a restrained movement against the upper surface of the pack of boards 12 and then released so that it exerts a pressure on the pile of boards by its own weight. The movements of the pressing element are controlled by the control unit (not shown in the figure).

It is obvious to the person skilled in the art that the invention is not limited to the embodiment described above, but that it may be varied within the scope of the following claims. The compression of the pile of boards can also be effected using e.g. a hydraulic or pneumatic cylinder or similar actuating devices and their combinations. The pack of boards may also be compressed e.g. by placing a fixed stop above the pack and lifting the pack from below against the top stop e.g. by means of a scissor table. The pack may also be compressed by pressing it simultaneously from both the lower and upper surfaces and so on. The sphere of application of the invention is not limited to boardlike objects; instead, it can also be applied in the case of other objects of suitable shape.

1. Method for marking objects, e.g. boardlike objects (11) arranged in a pile (12), in which method the objects are marked with a marking (14) printed by a print head (26) and containing e.g. information about the object,
characterized in that, to improve the marking quality, the objects are pressed together to reduce or eliminate gaps between them in the direction of compression, and that
the marking is made on an edge of the object that is parallel to the direction of compression of the objects.

2. Method according to claim 1, characterized in that the compression is implemented by pressing the pile from above by means of a pressing element (30) that presses the pile by its own weight.

3. Method according to claim 1, characterized in that the pressing element is moved vertically by
a motor drive, which, using a freewheel clutch, is caused to release the pressing element as it reaches the upper surface of the pile.

4. Apparatus for marking e.g. boardlike objects (11) arranged in a pile (12), by which apparatus the object is marked with a marking (14) produced by means of a print head (26) and containing e.g. information about the object,
characterized in that,
the apparatus comprises a pressing unit used to compress the objects to reduce or eliminate gaps between the objects in the direction of compression in order to improve the marking quality, and that
the print head (26) has been fitted to make the marking on an edge of the object that is parallel to the direction in which the objects are compressed.

5. Apparatus according to claim 4, characterized in that the pressing unit comprises a pressing element (30) that presses the pile from above by its own weight.

6. Apparatus according to claim 5, characterized in that the apparatus is provided with vertical guide bars (28) on which the pressing element is mounted and motor drive, by means of which the pressing element is moved vertically along the guide bars, and that the motor drive is provided with a freewheel clutch by means of which the pressing element is released as it reaches the upper surface of the pile.

7. Apparatus according to claim 4, characterized in that the pressing element comprised in the pressing unit is a press beam (30).
